(19) United States
(12) Patent Application Publication
(10) Pub. No.: US 2026/0242078 A1
(43) Pub. Date: Aug. 20, 2026

(54) INDUSTRIAL AERIAL ROBOT SYSTEMS AND METHODS

(71) Applicant: Thomas W. Melcher, Mesa, AZ (US)

(72) Inventor: Thomas W. Melcher, Mesa, AZ (US)

(21) Appl. No.: 18/999,824

(22) Filed: Dec. 23, 2024

Related U.S. Application Data
(63) Continuation of application No. PCT/US2023/026161, filed on Jun. 23, 2023.
(63) Continuation of application No. PCT/US2023/026157, filed on Jun. 23, 2023.
(63) Continuation of application No. PCT/US2023/026101, filed on Jun. 23, 2023.
(60) Provisional application No. 63/355,972, filed on Jun. 27, 2022.
(60) Provisional application No. 63/355,972, filed on Jun. 27, 2022.
(60) Provisional application No. 63/355,972, filed on Jun. 27, 2022.
(60) Provisional application No. 63/481,105, filed on Jan. 23, 2023.
(60) Provisional application No. 63/481,105, filed on Jan. 23, 2023.
(60) Provisional application No. 63/481,105, filed on Jan. 23, 2023.

(51) Int. Cl. B64U 20/96; B64U 50/19; B64U 50/30; B64U 70/50

(52) U.S. Cl. CPC B64U 20/96; B64U 50/19; B64U 50/30; B64U 70/50

(57) ABSTRACT

An aircraft has a fuselage, a propulsion system, and a vacuum control system. The vacuum control system includes a conduit having an inlet configured to receive exhaust air from the propulsion system. The conduit can be configured to direct the exhaust air through a nozzle for entraining an ambient air within the fuselage to generate a vacuum (or decreased air pressure) within one or more plenums located within the aircraft.

### CROSS REFERENCE TO RELATED APPLICATIONS

This application is a Continuation of International Application No. PCT/US2023/026161, entitled “INDUSTRIAL AERIAL ROBOT SYSTEMS AND METHODS,” filed on Jun. 23, 2023, which claims priority to, and the benefit of, U.S. Provisional Patent Application Ser. No. 63/355,972, entitled “INDUSTRIAL AERIAL ROBOT,” filed on Jun. 27, 2022, and further claims priority to, and the benefit of, U.S. Provisional Patent Application Ser. No. 63/481,105, entitled “INDUSTRIAL AERIAL ROBOT SYSTEMS AND METHODS,” filed on Jan. 23, 2023. This application is a Continuation of International Application No. PCT/US2023/026157, entitled “INDUSTRIAL AERIAL ROBOT SYSTEMS AND METHODS,” filed on Jun. 23, 2023, which claims priority to, and the benefit of, U.S. Provisional Patent Application Ser. No. 63/355,972, entitled “INDUSTRIAL AERIAL ROBOT,” filed on Jun. 27, 2022, and further claims priority to, and the benefit of, U.S. Provisional Patent Application Ser. No. 63/481,105, entitled “INDUSTRIAL AERIAL ROBOT SYSTEMS AND METHODS,” filed on Jan. 23, 2023. This application is a Continuation of International Application No. PCT/US2023/026101, entitled “INDUSTRIAL AERIAL ROBOT SYSTEMS AND METHODS,” filed on Jun. 23, 2023, which claims priority to, and the benefit of, U.S. Provisional Patent Application Ser. No. 63/355,972, entitled “INDUSTRIAL AERIAL ROBOT,” filed on Jun. 27, 2022, and further claims priority to, and the benefit of, U.S. Provisional Patent Application Ser. No. 63/481,105, entitled “INDUSTRIAL AERIAL ROBOT SYSTEMS AND METHODS,” filed on Jan. 23, 2023. The '161, '157, '101, '972, and '105 Applications are hereby incorporated by reference in their entirety for all purposes, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates in general to transportation systems, and, more particularly, to a transportation system using an electric vertical takeoff and landing (eVTOL) and short takeoff and landing (STOL) aircraft to transport heavy payloads.

### BACKGROUND

Aircraft carry different payloads, including for example, passengers, cargo, sensors, and munitions. Various requirements can shape an aircraft design; for example, some missions require flight in a certain speed regime, some missions require heavy payload-carrying capacity, while other missions require high fuel efficiency. Moreover, aircraft include various external aerodynamic surfaces (e.g., nacelles, fuselages, airfoils, control surfaces, etc.). Extensive resources have been exhausted for generated optimal shapes for these various external aerodynamic surfaces, for example to reduce drag and increase overall efficiency of the aircraft.

Active laminar flow control systems have been proposed for achieving and maintaining laminar flow on aircraft surfaces. One such technique is through boundary layer ingestion or suction, achieved using pumps (electric air pumps) disposed onboard the aircraft, where the boundary layer next to the aircraft surface is pulled through small holes in the surface to remove the low energy boundary layer and regenerate it or maintain it at a minimum or near minimum energy level. These active laminar flow control systems can be bulky, heavy, and require additional electric power components to operate.

In addition to the above, electric vehicles use battery power to enable vehicle functions. Modern battery technology requires careful thermal management during discharge to prevent undesired thermal events from disrupting optimal power delivery and, in some cases, damaging the battery and/or the vehicle itself. Inadequate thermal management of the battery can endanger the vehicle, its occupants, bystanders, and/or the surrounding environment. In addition, it is often desirable to charge the battery in a fast and efficient manner, which must be balanced against the heat generated within the battery by such charging processes. These challenges are compounded in contexts where the electric vehicle system design is subject to stringent constraints on weight, complexity, and/or safety, such as aviation.

### SUMMARY

In an exemplary embodiment, an aircraft comprises a fuselage, a propulsion system coupled to the fuselage, and a conduit coupled to the fuselage and comprising an inlet configured to receive exhaust air from the propulsion system.

In various embodiments, the conduit can comprise a nozzle. The nozzle can be disposed inside the fuselage. The conduit can be configured to direct the exhaust air through the nozzle for entraining an ambient air within the fuselage. The conduit can further comprise one or more perforations or opening for receiving the ambient air. The aircraft can further comprise a valve fluidly separating a first plenum within the fuselage from a second plenum within the fuselage. The nozzle can be located in the first plenum. A power source can be located in the second plenum. The valve can be configured to open to fluidly connect the first plenum with the second plenum and draw a cooling air across the power source. The conduit can further comprise an outlet for directing the exhaust air to a location located outside the fuselage

In an exemplary embodiment, a method for cooling a power source onboard an aircraft includes receiving exhaust air from a propulsion system at an inlet of a conduit, directing the exhaust air with the conduit, entraining ambient air from within a fuselage of the aircraft into the conduit using the exhaust air, decreasing a pressure of a compartment of the fuselage in response to the ambient air being entrained into the conduit, and drawing a cooling air across the power source in response to the pressure of the compartment decreasing.

In various embodiments, the cooling air can be drawn through an aerodynamic surface of the aircraft. The method can further comprise opening a valve to fluidly couple a first plenum in which the conduit is located to a second plenum in which the power source is located.

In an exemplary embodiment, an aircraft silo comprises a head configured to receive a propulsion system for an aircraft therein, a cylinder extending from the head and configured to receive a fuselage of the aircraft therein, and a piston located within the cylinder for launching the aircraft therefrom.

In various embodiments, the piston can be configured to be assisted by an exhaust air pressure generated by the aircraft. The aircraft silo can further comprise an electric motor/generator coupled to the piston via a wench, the wench configured to draw the piston into the cylinder against a thrust load of the aircraft. The aircraft silo can further comprise an ocean floor bracket, a wench coupled to the ocean floor bracket, and a silo attachment cable extending between the wench and the cylinder. The aircraft silo can further comprise a first plenum at least partially defined by the cylinder and a second plenum at least partially defined by the head, the first plenum and the second plenum being configured to direct a pressure generated by the propulsion system to the piston. The aircraft silo can further comprise an attachment dock coupled to the piston whereby the aircraft is configured to be attached to the piston. The aircraft silo can further comprise a plurality of locking mechanisms disposed around the head for attaching the aircraft silo to an adjacent aircraft silo.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the figures, wherein like numerals denote like elements.

FIG. 1 is a perspective view of a skyboom electric vertical takeoff and landing (eVTOL) aircraft, in accordance with various embodiments;

FIG. 2A is a schematic view of an eVTOL aircraft with a vacuum control system, in accordance with various embodiments;

FIG. 2B is an enlarged view of a conduit nozzle of the vacuum control system of FIG. 2A in accordance with various embodiments;

FIG. 3A and FIG. 3B are perspective views of an exemplary eVTOL aircraft with a vacuum control system with outer skins installed and omitted, respectively, in accordance with various embodiments;

FIG. 3C and FIG. 3D are enlarged perspective views of the exemplary eVTOL aircraft of FIG. 3A and FIG. 3B, respectively, in accordance with various embodiments;

FIG. 4 is a diagram illustrating a vacuum control system comprising a plurality of plenums interconnected via valves, in accordance with various embodiments;

FIG. 5 is a schematic view of a plurality of silo containers, in accordance with various embodiments;

FIG. 6 is a diagram illustrating a vacuum control system comprising a plurality of plenums interconnected via valves, in accordance with various embodiments; and

FIG. 7 is a diagram illustrating a vacuum control system comprising a plurality of plenums interconnected via valves, in accordance with various embodiments.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended statements.

For the sake of brevity, conventional techniques for electric motor construction, configuration, and use, as well as conventional techniques for rotor blade, stator blade, and nacelle management, operation, optimization, and/or control, may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical system or related methods of use.

The continuous vacuum technology used on the eVTOL aircraft of the present disclosure improves aerodynamic efficiency via induced laminar flow. Disrupting laminar flow via internal poppet valves provides a simplified method of control. The large electric turbine and high aspect ratio wings allow eVTOL aircrafts of the present disclosure to loiter for extended periods and cruise at high-altitude efficiency. The upper wings can be folded against the fuselage, using the large power turbine/diverter blades to support the front half of the aircraft during wing-borne flight.

Aircraft systems and methods of the present disclosure include a vacuum control arrangement for passively generating vacuum, or a pressure gradient, from an external volume (e.g., ambient air outside of the aircraft) and one or more internal volumes (e.g., one or more plenums defined internally to the aircraft). In various embodiments, a vacuum control arrangement of the present disclosure utilizes propulsion system exhaust air to entrain ambient air inside of the aircraft (e.g., inside of a fuselage of the aircraft) to draw air out of the aircraft and thereby create a vacuum or near vacuum. This pressure gradient can be used for drawing air through perforated surfaces of the aircraft (effectively changing the aerodynamic shape of the aircraft as desired) for passive laminar flow control, for creating a flow of cooling air across a thermally managed component (e.g., to create a thermal management system), or for various other controls whereby a pressure gradient is utilized.

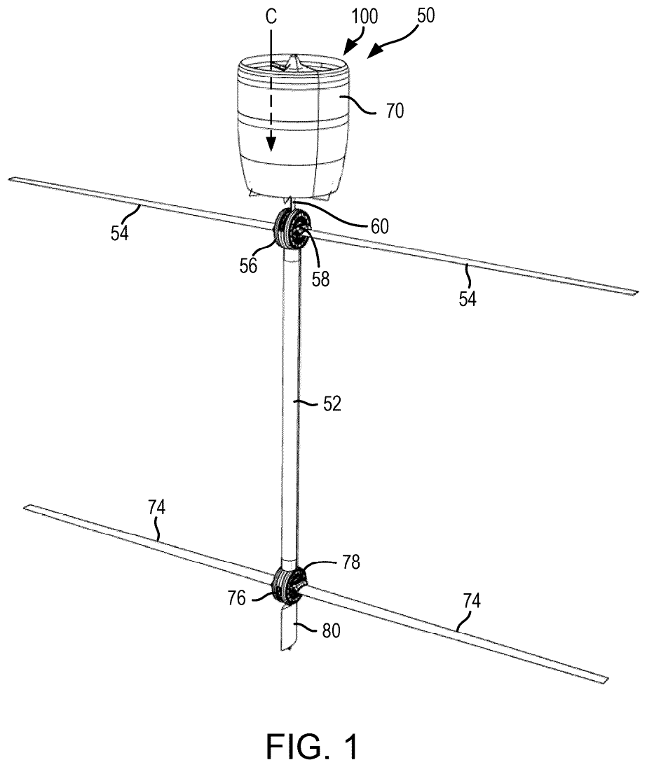

FIG. 1 illustrates a skyboom-based electric vertical takeoff and landing (eVTOL) aircraft 50. eVTOL aircraft 50 is an aircraft formed around a fuselage 52 (also referred to herein as a powerboom or skyboom). The top end of skyboom 52 has upper wings 54 attached via an articulated joint 56. Each upper wing 54 is attached to articulated joint 56 via a hinge 58. A rotor stanchion 60 extends from joint 56 and holds a propulsion system 100. The bottom end of skyboom 52 has lower wings 74 attached via articulated joint 76. Each lower wing 74 is attached to articulated joint 76 via a hinge 78. In this regard, articulated joint 56 may be disposed at a first end (also referred to herein as a top end or a front end) of skyboom 52 and joint 76 may be disposed at a second end (also referred to herein as a bottom end or an aft end) of skyboom 52. A payload connector 80 extends down from articulated joint 76. In various embodiments, payload connector 80 includes a shaft similar to stanchion 60 and can operate as a rudder with 360 degree rotation capability.

Skyboom 52 operates as the fuselage of eVTOL aircraft 50. The standard skyboom 52 can be 40 feet in length to support a combined wingspan of 160 feet for upper wings 54 and lower wings 74. In various embodiments, skyboom 52 acts as a torsion tube to accommodate differential loading between upper wings 54 and lower wings 74 (particularly when eVTOL aircraft 50 operates in rotorcraft mode). In the standard model, the combined wingspan of all four wings 54 and 74 is 100 feet: 60 feet for lower wings 74 and 40 feet for upper wings 54. Skyboom 52 houses fuel to power eVTOL aircraft 50. In the case of an all-electric eVTOL aircraft 50, skyboom 52 houses a large array of electric batteries. Standard battery weight for the all-electric eVTOL aircraft 50 can be 1,800-2,400 pounds, with an estimated total eVTOL weight of 3,600 to 4,000 pounds. The size, length, other dimensions described herein, and battery capacity of skyboom 52 are all scalable as desired to meet flight requirements for a given situation. Skyboom 52 has a symmetric airfoil shape to provide a large battery storage capacity in a low drag structure. In hybrid embodiments, skyboom 52 can house both electric batteries and liquid fuel. In various embodiments, other types of power storage can be used as a power source for eVTOL aircraft 50, such as fuel cells and capacitors, among others.

eVTOL aircraft 50 has two pairs of long high aspect ratio wings, upper wings 54 at the top of skyboom 52 and lower wings 74 at the bottom of skyboom 52. In various embodiments, upper wings 54 are optional, and some embodiments are capable of horizontal cruising with only lower wings 74. In other embodiments, smaller canards are used for upper wings 54. Articulated joints 56 and 76 allow wings 54 and 74, respectively, to rotate about an axis through the lengths of the wings. Wings 54 and 74 can be attached to circular rails, circular gears, or a ring gear within joints 56 and 76, respectively, that allow 360-degree rotation of the wings, about an axis down the length of the respective wings, using gears and electric drive motors. Rotation of wings 54 and 74 can also be passive. A locking mechanism can be used to temporarily disallow rotation of wings 54 and 74. Wings 54 and 74 may have additional control surfaces built into the wings, such as flaps or ailerons, for in-flight control. Otherwise, rotation via joints 56 and 76 can be used for in-flight control.

Articulated joint 56 allows wings 54 to rotate independently from each other. Articulated joint 76 allows wings 74 to rotate independently from each other. Rotating wings on opposite sides of skyboom 52 in opposite directions will effectively turn the wings into rotors to facilitate autorotation. In various embodiments, wing tips could be fitted with rockets to initiate autorotation. Rockets can be mounted directly to wing tips or within the wing structure with plumbing to a wing tip nozzle. In various embodiments, autorotation could be started by pressurized air jets. In various embodiments, autorotation could be started by rotating payload connector 80 (and the associated payload connected thereto if present), via articulated joint 76, which torque force is reacted through skyboom 52 causing the skyboom 52 and associated wings 54, 74 to counterrotate with respect to the payload connector 80. Autorotation can be particularly useful in reduced power or loss of power situations. In autorotation, the entire eVTOL aircraft 50 rotates, except for payload connector 80, in response to surrounding air moving upward relative to the eVTOL. In autorotation, skyboom 52 rotates about an axis through the length of the skyboom. An attached load could be geared through payload connector 80 to maintain set position or rotate in an opposite direction to induce a stabilizing effect.

Articulated joint 56 also allows stanchion 60, and thus propulsion system 100, to rotate relative to skyboom 52. As with wings 54, rotor stanchion 60 is attached to a circular rail or geared component within articulated joint 56 to allow rotation and powered by an electric drive motor and gears. Rotation of propulsion system 100 facilitates transition between horizontal and vertical flight by tilting thrust toward the desired direction of travel. Rotation of propulsion system 100 relative to skyboom 52 can be passive. With the rotor assembly dragging the skyboom behind, the wings provide lift to naturally bring eVTOL aircraft 50 into a horizontal posture. A locking mechanism (e.g., the collective cyclic-damping control mechanism(s) as described in greater detail herein) can be used to temporarily disallow rotation of propulsion system 100.

Articulated joint 76 allows connector 80 to rotate relative to skyboom 52. Connector 80 is attached to a circular rail or geared component within articulated joint 76 and powered by a driver motor and gears. Rotation of the connector 80 with respect to skyboom 52 can be passive, with a load causing connector 80 to remain hanging down vertically from articulated joint 76 as eVTOL aircraft 50 transitions between vertical and horizontal flight. When connector 80 is loaded and hangs down, the connector 80 stabilizes the flight of eVTOL aircraft 50 and functions as a tail rudder. When eVTOL aircraft 50 is unloaded, connector 80 can be extended upward or downward during horizontal flight as a vertical stabilizer. A locking mechanism can be used to temporarily disallow rotation of connector 80. The double-jointed design of eVTOL aircraft 50 with articulated joints at both ends allows counter-force to be applied to the propulsion system, reducing moments of instability during transition between horizontal and vertical flight.

The vertical design of eVTOL aircraft 50 with skyboom 52 provides a base structure to accommodate long folding wings 54 and 74 deployed from joints 56 and 76. Hinge 58 on joint 56 allows wings 54 to fold down onto skyboom 52, and hinge 78 on joint 76 allows wings 74 to fold up onto skyboom 52. In some embodiments, one or more sets of wings attached to skyboom 52 can be fixed rather than rotatable and foldable. Additional active wings, rudders, and other control surfaces can be mounted to skyboom 52 as desired for additional lift and control.

In some embodiments, upper wings 54, lower wings 74, or both can have a variable geometry. In one embodiment, hinges 78 allow lower wings 74 to sweep forward, in a similar rotation direction as classic variable sweep aircraft wings. Wings 74 would end up being oriented parallel to skyboom 52, but rotated approximately 90 degrees about an axis through the length of the wings so that the width of the wing extends out from the skyboom. Wings 74 would then operate similar to a long delta wing or chine. The tips of wings 74 can attach to the skyboom 52, so that articulated joint 76 warps wings 74 as a control surface. Upper wings 54 could be swept backwards similarly instead of or in addition to lower wings 74.

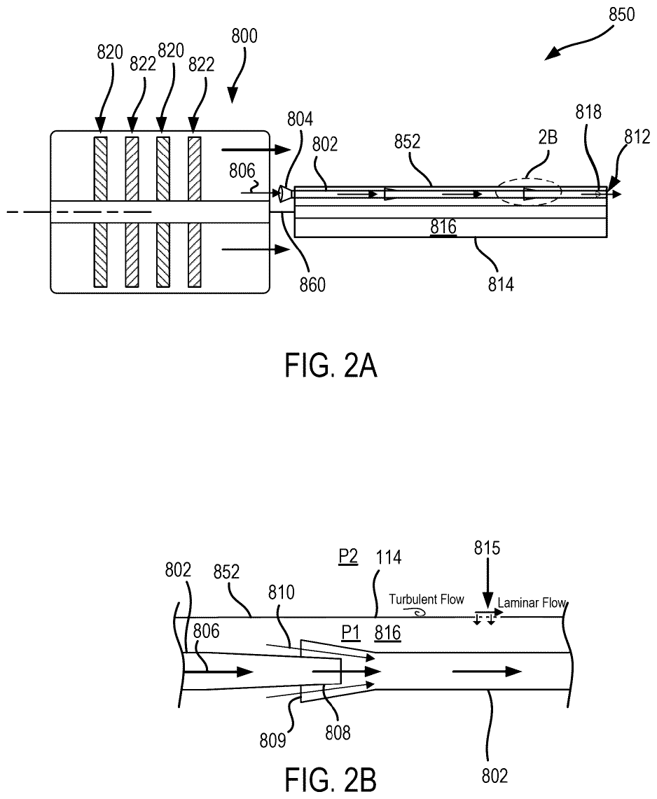

FIG. 2A is a schematic view of an electric vertical takeoff and landing (eVTOL) aircraft 850. eVTOL aircraft 850 can be similar to eVTOL aircraft 50 as described with respect to FIG. 1, in accordance with various embodiments. eVTOL aircraft 850 can be an aircraft formed around a fuselage 852 (also referred to herein as a powerboom or skyboom). Skyboom 852 may comprise an aerodynamic surface 814 defining a compartment 816 wherein various components of eVTOL aircraft 850 are disposed (e.g., batteries, wiring harness(es), stiffeners, etc.). A rotor stanchion 860 may extend from skyboom 852 and holds a propulsion system 800. Propulsion system 800 may comprise any suitable propulsor, such as a turbine engine having one or more rotor blade 820 and/or stator blade 822 arrays for generating thrust for eVTOL aircraft 850. A conduit 802 may extend from skyboom 852. An inlet 804 may be disposed at a first end (also referred to herein as a front end or a top end) of the conduit 802, downstream from propulsion system 800, and may receive exhaust air (represented by arrow 806) from propulsion system 800. In various embodiments, inlet 804 is disposed downstream from propulsion system 800 and upstream from skyboom 852. In this regard, ram air from the propulsion system 800 can be used to create continuous vacuum throughout the aircraft 850. Vacuum control systems of the present disclosure can improve aerodynamic efficiency via induced laminar flow.

FIG. 2B is an enlarged schematic view of the conduit 802 installed in skyboom 852. The exhaust air 806 may be compressed in conduit 802 to induce a primary air flow through conduit 802. Conduit 802 may comprise one or more nozzles 808. This primary air flow may flow through the one or more nozzles 808. This primary air flow may be a high velocity jet of air that creates a low pressure area around nozzle 808 which entrains the ambient air 810 within skyboom 852. For example, one or more perforations or openings 809 can be located in conduit 802 for receiving the entrained air therein. The opening 809 is configured to entrain ambient air 810 from within the aerodynamic surface 814 (fuselage) in response to the inlet 804 receiving the exhaust air 806 from the propulsion system 800. The air streams (i.e., exhaust air 806 and ambient air 810) combine past the tip of the nozzle 808 creating a vacuum within skyboom 852 (i.e., the static air pressure P1 within skyboom 852 is less than the static air pressure P2 outside of skyboom 852). Stated differently, a pressure P1 within the aerodynamic surface 814 (fuselage) is configured to be reduced (i.e., to be lower than the static pressure P2 outside of skyboom 852) in response to the opening 809 entraining ambient air 810 from within the skyboom 852. The air flow (i.e., exhaust air 806 and entrained ambient air 810) through conduit 802 may exit skyboom 852, for example at an outlet 812 (see FIG. 2A) of conduit 802 dispose at an aft end of skyboom 852. In this regard, conduit 802 and nozzle 808 can be arranged to form a venturi nozzle.

In various embodiments, skyboom 852 includes a perforated surface 815 for laminar flow control over aerodynamic surface 814. Laminar flow control can be performed at aerodynamic surface 814 to ingest the boundary layer and maintain laminar flow over the perforated surface 815 of the aerodynamic surface 814. Stated differently, conduit 802 may reduce pressure within skyboom 852 to act as a suction-type, laminar flow control through perforated surface 815 of the aerodynamic surface 814, whereby outside air is received through perforated surface 815 into skyboom 852 and eventually exhausted through outlet 812 (see FIG. 2A). In various embodiments, outlet 812 is located at an aft end of skyboom 852.

In various embodiments, a valve 818 (e.g., a butterfly valve or the like) can be located aft of one or more nozzles 808, wherein in response to the valve being actuated to a closed position, a portion of the aircraft is pressurized to clean out the perforations through the aerodynamic surface (e.g., perforated surface 815). For example, in response to valve 818 closing, exhaust air 806 can be blocked from exiting conduit 802 at outlet 812. In response thereto, pressure can build (i.e., increase) in compartment 816 (or other portions of the aircraft as desired, wherein the portions are in fluid communication with perforations, such as laminar flow control apertures) so as to reverse the flow of air through the perforations of the perforated surface 815 and clean out any particulates that may have accumulated thereon and/or therein. In this manner, the vacuum control system can be equipped with a reverse flow/self-cleaning feature controllable by the valve 818.

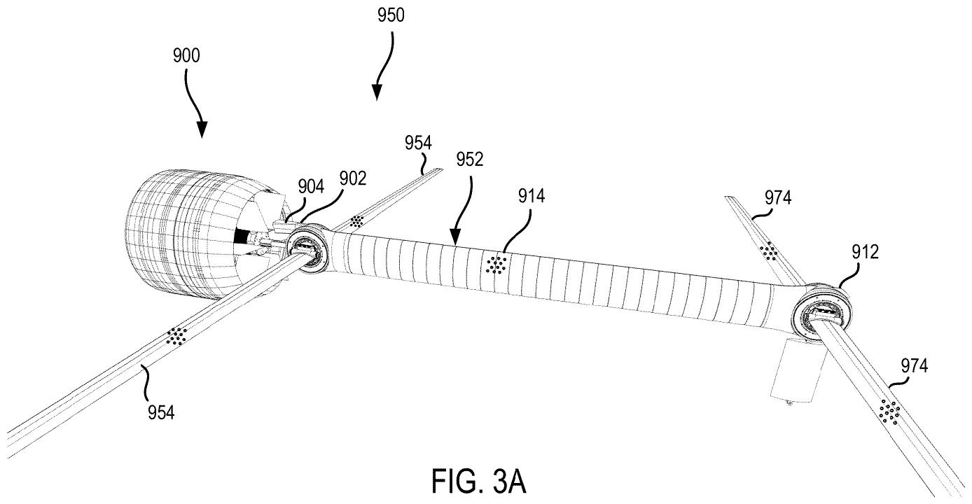

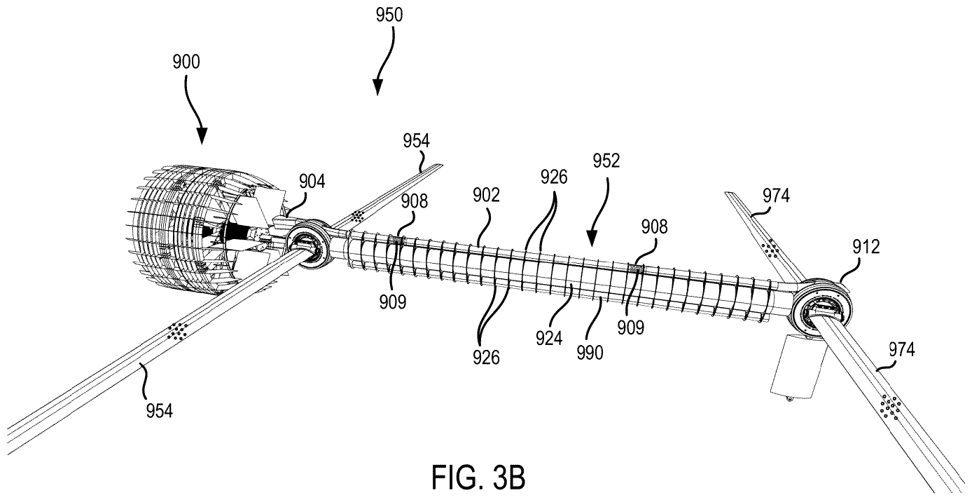

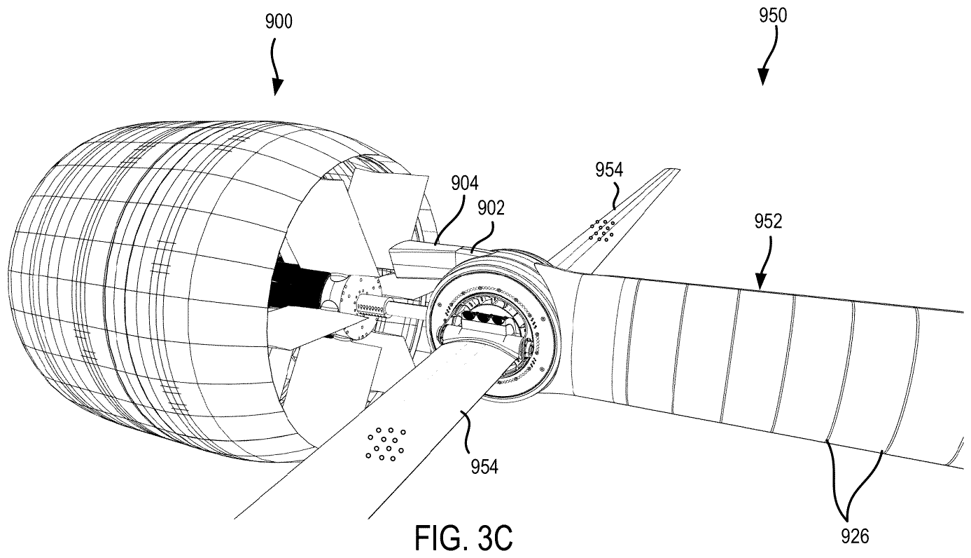

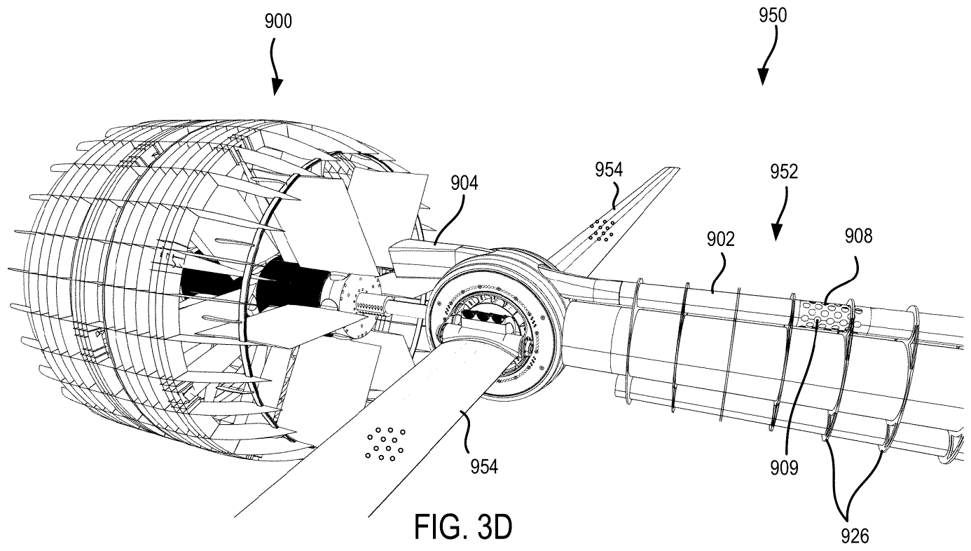

FIG. 3A, FIG. 3B, FIG. 3C, and FIG. 3D are perspective views of an eVTOL aircraft 950 having a vacuum control system for entraining air within the aerodynamic body 914 of skyboom 952, in accordance with one exemplary embodiment. In FIG. 3B and FIG. 3D, the aerodynamic body 914 and the shroud for the propulsion system 900 are omitted for ease of illustration. In various embodiments, the vacuum control system includes a conduit 902 configured to entrain air within the aerodynamic body 914 of skyboom 952. In various embodiments, conduit 902 is similar to conduit 802 as described with respect to FIG. 2A and FIG. 2B. Conduit 902 includes an inlet 904. Conduit 902 includes an outlet 912. Skyboom 952 may include a main support beam 924 and aerodynamic body 914 surrounding, and mounted to, the support beam 924. In various embodiments, skyboom 952 may further include a plurality of ribs 926 disposed along the length of support beam 924 for supporting aerodynamic body 914. In various embodiments, aerodynamic body 914 comprises a tube made from a metal alloy and/or a composite material. Ribs 926 may support aerodynamic body 914 from collapsing, particularly when aerodynamic body 914 is under vacuum. Ribs 926 may provide structural rigidity to aerodynamic body 914.

One or more nozzles 908 may be disposed along conduit 902 for entraining air from within aerodynamic body 914 to decrease pressure within aerodynamic body 914 (i.e., create a vacuum within aerodynamic body 914). In various embodiments, conduit 902 is supported by, and may extend through, ribs 926. Conduit 902 may include one or more perforations or openings 909 located at each nozzle 908 for receiving ambient air in aerodynamic body 914 to be entrained in the conduit 902.

In various embodiments, an auxiliary tube 990 is provided to house additional components, such as a power source (i.e., battery(ies), fuel cell(s), and/or super capacitor(s)), depending on the flight mission. Auxiliary tube 990 can extend along the length of support beam 924. Auxiliary tube 990 can be located opposite support beam 924 from conduit 902.

In various embodiments, vacuum can be used for laminar flow control over various aerodynamic surfaces of eVTOL aircraft 950 (e.g., shroud, fuselage/boom, wings, joints, and rudder). For example, when propulsion system 900 is running, vacuum can be created throughout eVTOL aircraft 950 as desired. Laminar flow control can be performed at an aerodynamic surface (e.g., on the suction side of an airfoil) to ingest the boundary layer and maintain laminar flow over the airfoil. In this regard, the passive vacuum system of the present disclosure allows for design of an airfoil that is optimized for vacuum. Turning off vacuum at an airfoil, or a section of an airfoil, can create drag (e.g., via flow separation) and thereby alter the attitude of the eVTOL aircraft 950. In this regard, various flight parameters of eVTOL aircraft 950 can be controlled by the vacuum system. In this regard, traditional flight controls (e.g., ailerons, flaps, etc.) can be replaced by the vacuum system of the present disclosure, in various embodiments.

In various embodiments, toggling vacuum at select points around the aircraft provides an augmented control system via induced drag. Toggling laminar flow along the wings can provide flutter suppression, allowing for flexible, slender, low-drag wings. Vacuum control systems of the present disclosure can allow for aircraft designed for high volume production (e.g., no vacuum bagging, no autoclaves, etc.).

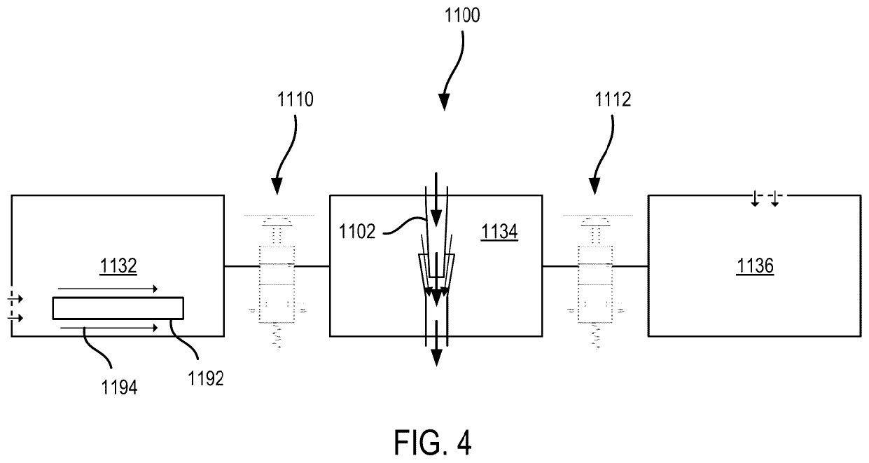

With momentary reference to FIG. 4, a vacuum system 1100 is schematically illustrated, in accordance with various embodiments. Vacuum system 1100 comprises a plurality of plenums (e.g., plenum 1132, plenum 1134, and plenum 1136) fluidly separated by valves (e.g., valve 1110 and valve 1112). In this regard, plenum 1132 can be fluidly separated from plenum 1134 by first valve 1110 and plenum 1134 can be fluidly separated from plenum 1136 by second valve 1112.

In various embodiments, and with additional reference to FIG. 3A, a plurality of plenums may be formed within a single aircraft component (e.g., similar to plenums 1132, 1134, and 1136 of FIG. 4). For example, the cowling (duct) of propulsion system 900, aerodynamic body 914, wings 954, wings 974, etc., each may comprise a plurality of plenums for controlling vacuum at various zones thereof. For example, skyboom 952 can be subdivided into a plurality of plenums where the vacuum control system separately draws vacuum, controllably, on each plenum so as to adjust aerodynamics (e.g., laminar flow, turbulent flow, boundary layer flow control, surface drag) independently at different zones of the skyboom 952. It should be understood that other components, for example the wings 954 and/or 974 can similarly be subdivided for flow control over various zones of the wings 954 and/or 974. In this manner, the orientation (e.g., attitude, altitude, pitch, roll, yaw, etc.) of eVTOL aircraft 950 can be controlled using the vacuum control system. Accordingly, various traditional control surfaces (e.g., ailerons, elevator, stabilator, rudder, flaps, slats, etc.) can be omitted in place of a vacuum control system of the present disclosure; however, in various embodiments, a vacuum control system of the present disclosure can be used together with one or more of the aforementioned control surfaces. Accordingly, the vacuum control system of the present disclosure can minimize moving parts of eVTOL aircraft 950.

Having described use of a plurality of sub-plenums in a single component, it is further contemplated herein that each plenum of the vacuum control system, in various embodiments, can be disposed in a different aircraft component. For example, plenum 1134 can be disposed in (or at least partially defined by) aerodynamic body 914, plenum 1136 can be disposed in (or at least partially defined by) wings 954, and plenum 1132 can be disposed in (or at least partially defined by) wings 974.

In various embodiments, valve 1110 and valve 1112 comprise poppet valves that can pneumatically (e.g., via the vacuum pressure of vacuum system 1100) controlled or electrically controlled (e.g., via a battery). In various embodiments, where valves 1110, 1112 are electrically controlled, a control unit, which includes one or more controllers (e.g., processors) and one or more tangible, non-transitory memories capable of implementing digital or programmatic logic, can be provided for controlling a state (e.g., open or closed) of the valves 1110, 1112.

A conduit 1102 can extend through one of the plenums (e.g., plenum 1134). Conduit 1102 may be similar to conduit 802 as described with respect to FIG. 2A and FIG. 2B and/or conduit 902 as described with respect to FIG. 3A through FIG. 3D, in accordance with various embodiments. In this regard, conduit 1102 may pull air out of plenum 1134 to create a vacuum (or decreased pressure) therein by entraining ambient air within plenum 1134 into conduit 1102. In response to valve 1110 moving from a closed state to an open state, air within plenum 1132 may be pulled into plenum 1134 (due to the decreased pressure within plenum 1134) and a vacuum can similarly be created in plenum 1132. Closing valve 1110 can stop the vacuum from being created in plenum 1132. Similarly, in response to valve 1112 moving from a closed state to an open state, air within plenum 1136 may be pulled into plenum 1134 (due to the decreased pressure within plenum 1134) and a vacuum can similarly be created in plenum 1136. Closing valve 1112 can stop the vacuum from being created in plenum 1136. In this manner, vacuum at various aircraft components (or various zones of a single aircraft component) can be controlled simply using valves that separate plenums. For example, a flow of ambient air around various zones of an eVTOL aircraft wing/rotor blade (e.g., wing 954 and/or wing 974) can be manipulated during flight to control the flight (e.g., position, attitude, yaw, lift, efficiency, etc.) of the eVTOL aircraft 950. One or more plenum 1132, 1134, and/or 1136 can be in fluid communication with perforations of an aerodynamic surface (e.g., see perforated surface 815 of FIG. 2B and perforated surfaces of FIG. 3A through FIG. 3D) whereby laminar flow control is turned on or off.

In various embodiments, and with continued reference to FIG. 4, vacuum can be used to control thermal loads within individual battery modules, thereby eliminating the need for fluid cooling with solid-state batteries. For example, a cooling air can be drawn (using the vacuum control system) across, over, and/or through, a battery module whereby heat is transferred from the battery module to the cooling air. In various embodiments, one or more plenum comprises a power source (e.g., a battery module or any other suitable power source) whereby air is drawn through the plenum to create a flow of cooling air over, around, or through the power source to maintain the power source within a predetermined temperature envelope. For example, a power source 1192 can be disposed in plenum 1132 and valve 1110 can be opened to draw a cooling air flow 1194 over, around, and/or through the power source 1192 to cool the power source 1192. In various embodiments, the cooling air flow 1194 is drawn from outside the plenum 1132, across the power source 1192, and exhausted out conduit 1102. In various embodiments, the vacuum control system cools the cooling air flow 1194 by reducing a pressure of the air flow 1194 as it enters the plenum 1132. Accordingly, in various embodiments, the vacuum control system of the present disclosure can be particularly desirable for generating cooling air flows due to the reduced air pressure generated thereby. In this manner, vacuum system 1100 can be used for cooling various aircraft components. For example, the power source 1192 can include power electronics where cooling is desired.

In various embodiments, creating vacuum within various components (e.g., the cowling (duct) of propulsion system 900, aerodynamic body 914, wings 954, 974, etc.) of eVTOL aircraft 950 may increase rigidity thereof.

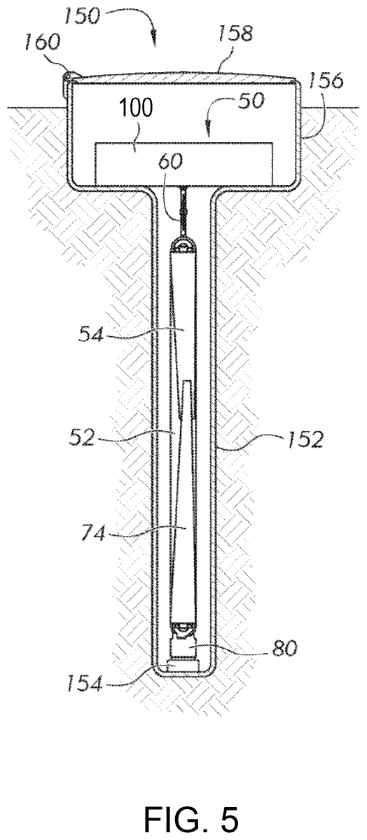

FIG. 5 illustrates a storage silo 150 with an eVTOL 50 parked within the storage silo 150. The storage silo 150 includes a long, thin cylinder 152 that a skyboom 52 can descend into with wings 74 and 54 folded down. A dock 154 at the bottom of cylinder 152 provides a connection to eVTOL 50 for recharging the batteries, downloading or uploading data, or performing diagnostics. Dock 154 connects to payload connector 80, similar to dock 132 of vehicle 130. The walls of cylinder 152 can include cameras, sensors, or other components to perform physical diagnostics on eVTOL 50. Diagnostics can also be performed via the data connection of dock 154. Walls of cylinder 152 may also include water spouts, brushes, and other elements to clean eVTOL 50 while parked.

Head 156 of storage silo 150 is sized to fit propulsion system 100, or any other propulsion system in use for a particular eVTOL. In one embodiment, propulsion system 100 of eVTOL 50 rests on a bottom surface of head 156 when parked, and skyboom 52 hangs below the rotor assembly. In other embodiments, dock 154 supports the weight of eVTOL 50 at the bottom of cylinder 152. A lid 158 protects the inside of silo 150, including eVTOL 50 when parked, from rain and other weather conditions, local wildlife, or criminal theft or damage. A hinge 160 allows lid 158 to open for takeoff or landing of eVTOL 50.

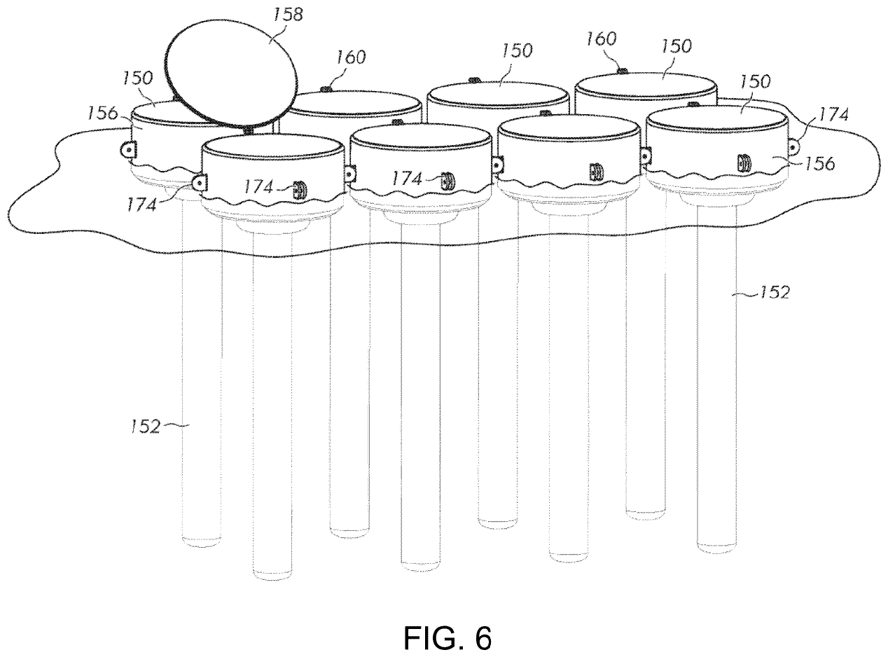

Cities adjacent to waterfronts can store a plurality of silos 150 locked together in floating and/or underwater grids. FIG. 6 illustrates several silos 150 locked together in a body of water. The silos 150 can include a plurality of locking mechanisms 174 (e.g., four locking mechanisms 174) for attaching the silo 150 to an adjacent silo 150. The locking mechanisms 174 can be located orthogonally around the head 156 of each silo 150. For example, each locking mechanism 174 can be spaced approximately ninety degrees apart from one another around the perimeter of the head. Locking mechanisms 174 attach to each other mechanically to keep the silos from moving away from each other. Lid 158 can have a built-in lifting mechanism allowing an eVTOL 50 to lift the entire silo 150, allowing the eVTOLs to self-assemble the grid system.

The floating silos 150 can have power generation capability that powers the silos and recharges eVTOL 50 using wave power from the surrounding water. Power can also be generated from solar panels in lids 158. In one embodiment, each silo 150 in an array is totally self-sufficient and includes batteries to store wave and solar power for charging an eVTOL 50. In other embodiments, each silo includes a small battery, with one or more silos 150 totally dedicated to housing batteries for power storage without the capability to park an eVTOL 50. Silos 150 can transmit power between each other through electrical interconnects at locking mechanisms 174. Status information and other data can also be transmitted through electrical interconnects at locking mechanisms 174. One or more dedicated silos 150 could also be filled with liquid fuel to refuel jet eVTOLs 50 and hybrid eVTOLs.

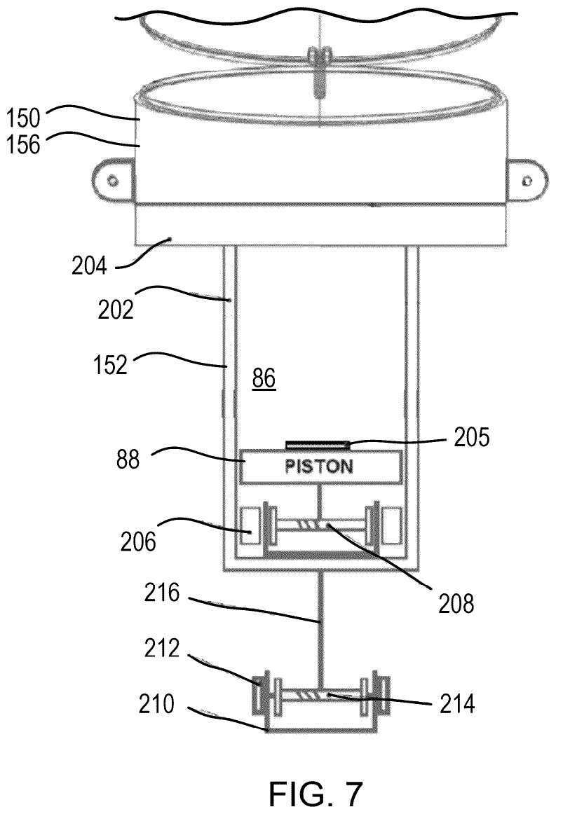

With reference to FIG. 7, one or more silos 150 can be equipped with a piston 88 which generates upward force to assist launching the eVTOL aircraft upward into the air after which the propulsion system takes over in generating all of the upward thrust for maintaining vertical flight of the eVTOL aircraft. In various embodiments, core air flow from propulsion system 100 is used to assist operation of the piston 88. For example, propulsion system 100 may be spun up until sufficient air pressure exists in chamber 86 to activate the piston 88, at which time the piston 88 may be released to launch the eVTOL aircraft 50 from container 85. An attachment dock 205 can be mounted to the piston 88 for coupling the eVTOL aircraft to the piston 88.

In various embodiments, additional volume can be provided within the head 156 and cylinder 152 of the silo 150, as desired, to provide sufficient force to the piston 88 as it travels up the cylinder 152 during the launch of the eVTOL aircraft. For example, a first plenum 202 can be located around the cylinder 152 and/or a second plenum 204 can be located at a bottom portion of the head 156. The first plenum 202 can be in fluid communication with the second plenum 204 such that exhaust air travels from the second plenum 204 into the first plenum 202 and to the piston 88 for biasing the piston 88 up the cylinder 152 for launching the eVTOL aircraft.

In various embodiments, an electric motor/generator 206 can be provided to retrieve the piston 88. Electric motor/generator 206 can include a rotary damping system to control piston velocity. These systems can be combined using the hydraulic fluid to drive the generators, directly or through accumulators. A wench 208 can be provided to operate the piston 88. The wench 208 can be configured to draw piston 88 down into the silo 150 after the eVTOL aircraft is attached to the piston 88. The wench can have sufficient torque to draw the eVTOL aircraft into the silo 150 while under propulsive thrust. Drawing the eVTOL aircraft into the silo 150 while under the thrust load tends to provide stability to the eVTOL aircraft during silo docking.

An ocean floor bracket 210 can be provided for anchoring the silo 150 to the floor of the ocean (or other body of water). The ocean floor bracket 210 can be bolted to a weighted mass. An electric motor/generator 212 can be provided together with a wench 214 to secure the silo 150 to the ocean floor bracket 210. Electric motor/generator 212 can include adjustable rotation stops. Electric motor/generator 212 can be spring loaded. The wench 214 can be used to pull silo 150 into position. In various embodiments, the wench 214 can be used to generate electrical current supplied to batteries located within the silo 150. For example, tension on silo attachment cable 216 (e.g., generated by ocean waves, etc.) can cause wench 214, which can include an electric motor that converts the rotational mechanical energy into electrical energy, to spin.

A silo attachment cable 216 can extend between the wench 214 and the silo 150. The silo attachment cable 216 can be used for silo retention, positioning, and electrical supply for charging silo batteries. Surplus energy can be routed on-shore to supply electricity to the electrical grid.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, a thermal connection, and/or any other connection. When language similar to “at least one of A, B, or C” or “at least one of A, B, and C” is used in the specification or claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. An aircraft comprising:
a fuselage;
a propulsion system coupled to the fuselage; and
a conduit coupled to the fuselage and comprising an inlet configured to receive exhaust air from the propulsion system.

2. The aircraft of claim 1, wherein the conduit comprises a nozzle.

3. The aircraft of claim 2, wherein the nozzle is disposed inside the fuselage.

4. The aircraft of claim 3, wherein the conduit is configured to direct the exhaust air through the nozzle for entraining an ambient air within the fuselage.

5. The aircraft of claim 4, wherein the conduit further comprises one or more perforations or opening for receiving the ambient air.

6. The aircraft of claim 4, further comprising a valve fluidly separating a first plenum within the fuselage from a second plenum within the fuselage.

7. The aircraft of claim 6, wherein the nozzle is located in the first plenum.

8. The aircraft of claim 7, wherein a power source is located in the second plenum.

9. The aircraft of claim 8, wherein the valve is configured to open to fluidly connect the first plenum with the second plenum and draw a cooling air across the power source.

10. The aircraft of claim 7, wherein the conduit further comprises an outlet for directing the exhaust air to a location located outside the fuselage.

11. A method for cooling a power source onboard an aircraft, comprising:
receiving exhaust air from a propulsion system at an inlet of a conduit;
directing the exhaust air with the conduit;
entraining ambient air from within a fuselage of the aircraft into the conduit using the exhaust air;
decreasing a pressure of a compartment of the fuselage in response to the ambient air being entrained into the conduit; and
drawing a cooling air across the power source in response to the pressure of the compartment decreasing.

12. The method of claim 11, wherein the cooling air is drawn through an aerodynamic surface of the aircraft.

13. The method of claim 11, further comprising opening a valve to fluidly couple a first plenum in which the conduit is located to a second plenum in which the power source is located.

14. An aircraft silo, comprising:
a head configured to receive a propulsion system for an aircraft therein;
a cylinder extending from the head and configured to receive a fuselage of the aircraft therein; and
a piston located within the cylinder for launching the aircraft therefrom.

15. The aircraft silo of claim 14, wherein the piston is configured to be assisted by an exhaust air pressure generated by the aircraft.

16. The aircraft silo of claim 14, further comprising an electric motor/generator coupled to the piston via a wench, the wench configured to draw the piston into the cylinder against a thrust load of the aircraft.

17. The aircraft silo of claim 14, further comprising an ocean floor bracket, a wench coupled to the ocean floor bracket, and a silo attachment cable extending between the wench and the cylinder.

18. The aircraft silo of claim 14, further comprising a first plenum at least partially defined by the cylinder and a second plenum at least partially defined by the head, the first plenum and the second plenum being configured to direct a pressure generated by the propulsion system to the piston.

19. The aircraft silo of claim 14, further comprising an attachment dock coupled to the piston whereby the aircraft is configured to be attached to the piston.

20. The aircraft silo of claim 14, further comprising a plurality of locking mechanisms disposed around the head for attaching the aircraft silo to an adjacent aircraft silo.
